(19) United States
(12) Patent Application Publication
(10) Pub. No.: US 2021/0331436 A1
(43) Pub. Date: Oct. 28, 2021

(54) MANUFACTURING PROCESSES FOR MAKING LIGHTWEIGHT COMPOSITE SOLES

(71) Applicant: GIA-JIU ENTERPRISE MFG. CORPORATION, TAICHUNG CITY (TW)

(72) Inventor: CHIH-HSIUNG KUO, TAICHUNG CITY (TW)

(21) Appl. No.: 16/606,098

(22) PCT Filed: Jan. 18, 2019
(86) PCT No.: PCT/CN2019/072250

§ 371 Date: Oct. 17, 2019

(51) Int. Cl. B29D 35/14; B29C 44/12; B29C 44/34; B29C 44/02

(52) U.S. Cl. CPC B29D 35/142; B29C 44/1271; B29K 2075/00; B29C 44/025; B29C 44/3442

(57) ABSTRACT

The manufacturing processes for making lightweight composite soles include a supercritical foaming step that adds a water dispersant and TPU particles sequentially into an autoclave, introduces carbon dioxide and nitrogen gas into the autoclave, and blends the mixture in the autoclave to produce TPU foamed particles; a mixing step that mixes the TPU foamed particles with a PU glue, and a portion of the PU glue covers the TPU foamed particles, the surfaces of the TPU foamed particles do not touch one another; a clamping step that spreads a TPU film in a cavity of a shoe mold, fills a foaming shoe material into the cavity; a baking step that places the clamped shoe mold into an oven; and a finished-product step that removes the shoe mold from the oven to get a composite sole covered with PU and having the TPU foamed particles and combined with the TPU film.

### BACKGROUND OF THE INVENTION

### 1. Fields of the Invention

The present invention relates to manufacturing processes for making lightweight composite soles.

### 2. Descriptions of Related Art

The conventional shoes include a sole which absorbs shocks transferred from the ground and provides buffering feature so as to protect the wearer's ankle and knees.

There are two soles that are widely used on shoes, the first sole is directly foamed from Ethylene Vinyl Acetate resin. The Ethylene Vinyl Acetate resin is heated under certain pressure in a mold set so as to have the foamed sole. The sole is deformable when a force or pressure is applied to the sole so as to have the buffering feature. The second sole includes buffering air-cushion received therein. The air-cushion is deformable when a force or pressure is applied to the sole.

However, the first sole is made by a single material and the buffering feature reduces gradually after a period of use. Therefore, the sole made of Ethylene Vinyl Acetate resin cannot protect the user's knee and ankle when it is used for a period of time. The air-cushion of the second sole may be broken or may leak. Water may enter into the shoes with the second sole.

The present invention intends to provide manufacturing processes for making lightweight composite soles, and which improve the shortcomings mentioned above.

### SUMMARY OF THE INVENTION

The present invention provides manufacturing processes for making lightweight composite sole, and comprises a supercritical foaming step that adds a water dispersant and TPU particles sequentially into an autoclave, introduces carbon dioxide and nitrogen gas into the autoclave until the internal pressure of the autoclave is 9˜11 MPa, stops passing the carbon dioxide and nitrogen gas into the autoclave, blends the mixture in the autoclave by a blender, heats the autoclave and controls the internal temperature of the autoclave within a range from 100° C. to 150° C. for 1 to 2 hours, controls the saturation time of the TPU particles to be 1.5 to 3 hours, stops the blender and then opens a valve of the autoclave to relieve pressure, and finally produces TPU foamed particles with a specific gravity with a range from 0.1 g/cm³ to 0.12 g/cm³; a mixing step that mixes the TPU foamed particles with a PU glue to produce a viscous foaming substrate, and a portion of the PU glue covers the TPU foamed particles, such that the surfaces of the TPU foamed particles do not touch one another; a clamping step that spreads a TPU film in a cavity of a shoe mold, fills a foaming shoe material into the cavity, and clamps the shoe mold after stacking the foaming shoe material on the TPU film; a baking step that places the clamped shoe mold into an oven at a temperature from 100° C. to 140° C. for 8 minutes to 13 minutes; and a finished-product step that removes the shoe mold from the oven, opens the mold to have a composite sole covered with PU having the TPU foamed particles, and combined with the TPU film.

Preferably, the foaming substrate used in the mixing step includes water, a catalyst, and an anti-yellowing agent. The PU glue, the water, the catalyst, the anti-yellowing agent, and TPU foamed particles are put into a mixing bucket and blended and mixed with the foaming substrate for 3˜5 seconds in the mixing bucket.

Preferably, the foaming substrate is blended and mixed in the mixing bucket that is heated to a temperature of 30° C. to 40° C.

Preferably, the PU glue and the TPU foamed particles mixed in the mixing step have a mixing ratio of 7:3, and the viscosity of the PU glue is 2000˜3500 mPa·s (at 25° C.).

Preferably, the catalyst is a polyurethane catalyst, and the anti-yellowing agent is an ultraviolet absorber or an anti-UV stabilizer. The water has a content percentage of 0.1%˜3%, the catalyst has a content percentage of 0.8%˜3%, and the anti-yellowing agent has a content percentage of 8%.

Preferably, the water dispersant includes water, a surfactant, and an entrainer. The mass proportion of the water, the surfactant, and the entrainer falls within a range of 1:0.03:0.015 to 1:0.008:0.04.

Preferably, the surfactant is one selected from the group consisting of sodium dodecyl sulfate and cetyltrimethylammonium bromide, and the entrainer is one selected from the group consisting of cyclopentane, n-butane, ethanol, and acetone.

### DETAILED DESCRIPTION OF THE PREFERRED EMBODIMENT

The present invention provides manufacturing processes for making lightweight composite sole, and the manufacturing processes comprises:

a supercritical foaming step that adds a water dispersant and TPU particles sequentially into an autoclave, introduces carbon dioxide and nitrogen gas into the autoclave until the internal pressure of the autoclave is 9˜11 MPa, stops passing the carbon dioxide and nitrogen gas into the autoclave, blends the mixture in the autoclave by a blender, heats the autoclave and controls the internal temperature of the autoclave within a range from 100° C. to 150° C. for 1 to 2 hours, controls the saturation time of the TPU particles to be 1.5 to 3 hours, stops the blender and then opens a valve of the autoclave to relieve pressure, and finally produces TPU foamed particles with a specific gravity with a range from 0.1 g/cm³ to 0.12 g/cm³;

a mixing step that mixes the TPU foamed particles with a PU glue to produce a viscous foaming substrate, and a portion of the PU glue covers the TPU foamed particles, such that the surfaces of the TPU foamed particles do not touch one another;

a clamping step that spreads a TPU film in a cavity of a shoe mold, fills a foaming shoe material into the cavity, and clamps the shoe mold after stacking the foaming shoe material on the TPU film; and

a baking step that places the clamped shoe mold into an oven at a temperature from 100° C. to 140° C. for 8 minutes to 13 minutes; and a finished-product step that removes the shoe mold from the oven, opens the mold to have a composite sole covered with PU having the TPU foamed particles, and combined with the TPU film.

The TPU particles are improved by the supercritical foaming step and obtain the TPU foamed particles with specific weight so that after the TPU foamed particles are mixed with the PU glue, and are processed by the steps of clamping and the step of baking to obtain the sole that includes foamed PU and TPU foamed particles, so that the sole includes two different elasticity and buffering features. The TPU film enhances the sole which is durable and anti-scratch. The composite and light weight sole made of the present invention includes better structural strength and does not break.

Preferably, the PU glue and the TPU foamed particles mixed in the mixing step have a mixing ratio of 7:3, and the viscosity of the PU glue is 2000˜3500 mPa·s (at 25° C.). The foaming substrate used in the mixing step includes water, a catalyst, and an anti-yellowing agent. The PU glue, the water, the catalyst, the anti-yellowing agent, and TPU foamed particles are put into a mixing bucket and blended and mixed with the foaming substrate for 3˜5 seconds in the mixing bucket. The foaming substrate is blended and mixed in the mixing bucket that is heated to a temperature of 30° C. to 40° C.

The catalyst is a polyurethane catalyst, and the anti-yellowing agent is an ultraviolet absorber or an anti-UV stabilizer. The water has a content percentage of 0.1%˜3%, the catalyst has a content percentage of 0.8%˜3%, and the anti-yellowing agent has a content percentage of 8%.

The water dispersant includes water, a surfactant, and an entrainer. The mass proportion of the water, the surfactant, and the entrainer falls within a range of 1:0.03:0.015 to 1:0.008:0.04.

The surfactant is one selected from the group consisting of sodium dodecyl sulfate and cetyltrimethylammonium bromide, and the entrainer is one selected from the group consisting of cyclopentane, n-butane, ethanol, and acetone.

While we have shown and described the embodiment in accordance with the present invention, it should be clear to those skilled in the art that further embodiments may be made without departing from the scope of the present invention.

1. Manufacturing processes for making lightweight composite soles, comprising:
a supercritical foaming step that adds a water dispersant and TPU particles sequentially into an autoclave, introduces carbon dioxide and nitrogen gas into the autoclave until the internal pressure of the autoclave is 9˜11 MPa, stops passing the carbon dioxide and nitrogen gas into the autoclave, blends a mixture in the autoclave by a blender, heats the autoclave and controls the internal temperature of the autoclave within a range from 100° C. to 150° C. for 1 to 2 hours, controls the saturation time of the TPU particles to be 1.5 to 3 hours, stops the blender and then opens a valve of the autoclave to relieve pressure, and finally produces TPU foamed particles with a specific gravity with a range from 0.1 g/cm³ to 0.12 g/cm³;
a mixing step that mixes the TPU foamed particles with a PU glue to produce a viscous foaming substrate, and a portion of the PU glue covers the TPU foamed particles, surfaces of the TPU foamed particles do not touch one another;
a clamping step that spreads a TPU film in a cavity of a shoe mold, fills a foaming shoe material into the cavity, and clamps the shoe mold after stacking the foaming shoe material on the TPU film;
a baking step that places the clamped shoe mold into an oven at a temperature from 100° C. to 140° C. for 8 minutes to 13 minutes; and
a finished-product step that removes the shoe mold from the oven, opens the mold to have a composite sole covered with PU having the TPU foamed particles, and combined with the TPU film.

2. The manufacturing processes for making lightweight composite soles according to claim 1, wherein the foaming substrate used in the mixing step includes water, a catalyst, and an anti-yellowing agent, the PU glue, the water, the catalyst, the anti-yellowing agent, and the TPU foamed particles are put into a mixing bucket and blended and mixed with the foaming substrate for 3˜5 seconds in the mixing bucket.

3. The manufacturing processes for making lightweight composite soles according to claim 2, wherein the foaming substrate is blended and mixed in the mixing bucket that is heated to a temperature of 30° C. to 40° C.

4. The manufacturing processes for making lightweight composite soles according to claim 3, wherein the PU glue and the TPU foamed particles mixed in the mixing step have a mixing ratio of 7:3, and the viscosity of the PU glue is 2000˜3500 mPa·s (at 25° C.).

5. The manufacturing processes for making lightweight composite soles according to claim 4, wherein the catalyst is a polyurethane catalyst, and the anti-yellowing agent is a ultraviolet absorber or an anti-UV stabilizer, the water has a content percentage of 0.1%˜3%, the catalyst has a content percentage of 0.8%˜3%, and the anti-yellowing agent has a content percentage of 8%.

6. The manufacturing processes for making lightweight composite soles according to claim 1, wherein the water dispersant includes water, a surfactant, and an entrainer, the mass proportion of the water, the surfactant and the entrainer falls within a range of 1:0.03:0.015 to 1:0.008:0.04.

7. The manufacturing processes for making lightweight composite soles according to claim 6, wherein the surfactant is one selected from the group consisting of sodium dodecyl sulfate and cetyltrimethylammonium bromide, and the entrainer is one selected from the group consisting of cyclopentane, n-butane, ethanol, and acetone.

8. The manufacturing processes for making lightweight composite soles according to claim 2, wherein the water dispersant includes water, a surfactant, and an entrainer, the mass proportion of the water, the surfactant and the entrainer falls within a range of 1:0.03:0.015 to 1:0.008:0.04.

9. The manufacturing processes for making lightweight composite soles according to claim 3, wherein the water dispersant includes water, a surfactant, and an entrainer, the mass proportion of the water, the surfactant and the entrainer falls within a range of 1:0.03:0.015 to 1:0.008:0.04.

10. The manufacturing processes for making lightweight composite soles according to claim 4, wherein the water dispersant includes water, a surfactant, and an entrainer, the mass proportion of the water, the surfactant and the entrainer falls within a range of 1:0.03:0.015 to 1:0.008:0.04.

11. The manufacturing processes for making lightweight composite soles according to claim 5, wherein the water dispersant includes water, a surfactant, and an entrainer, the mass proportion of the water, the surfactant and the entrainer falls within a range of 1:0.03:0.015 to 1:0.008:0.04.

12. The manufacturing processes for making lightweight composite soles according to claim 8, wherein the surfactant is one selected from the group consisting of sodium dodecyl sulfate and cetyltrimethylammonium bromide, and the entrainer is one selected from the group consisting of cyclopentane, n-butane, ethanol, and acetone.

13. The manufacturing processes for making lightweight composite soles according to claim 9, wherein the surfactant is one selected from the group consisting of sodium dodecyl sulfate and cetyltrimethylammonium bromide, and the entrainer is one selected from the group consisting of cyclopentane, n-butane, ethanol, and acetone.

14. The manufacturing processes for making lightweight composite soles according to claim 10, wherein the surfactant is one selected from the group consisting of sodium dodecyl sulfate and cetyltrimethylammonium bromide, and the entrainer is one selected from the group consisting of cyclopentane, n-butane, ethanol, and acetone.

15. The manufacturing processes for making lightweight composite soles according to claim 11, wherein the surfactant is one selected from the group consisting of sodium dodecyl sulfate and cetyltrimethylammonium bromide, and the entrainer is one selected from the group consisting of cyclopentane, n-butane, ethanol, and acetone.
